(19) United States
(12) Patent Application Publication
(10) Pub. No.: US 2006/0138212 A1
(43) Pub. Date: Jun. 29, 2006

(54) Wireless authentication system

(76) Inventor: Shroeder Prudent, Brooklyn, NY (US)

Correspondence Address: SHROEDER PRUDENT, 983 EAST 82nd Street, BROOKLYN, NY, 11236, US

(21) Appl. No.: 11/293,713

(22) Filed: Dec. 1, 2005

Related U.S. Application Data
(60) Provisional application No. 60/632,717, filed on Dec. 3, 2004.

(51) Int. Cl. G06F 17/00

(52) U.S. Cl. 235/375

(57) ABSTRACT

This invention depicts a wireless authentication system in which an object's authenticity can be quickly obtained using a cell phone or any wireless web enable device.

### CROSS REFERENCE TO RELATED APPLICATIONS

This application is an original patent application based on provisional application Ser. No. 60/632,717, filed Dec. 3, 2004, and derives its priority there from.

### TECHNICAL FIELD

The present invention relates generally to a communication system for transmission and reception of data over a wireless network using wireless Web technology and transmission and reception of data over a local area wireless network.

### BACKGROUND

Counterfeiting is one of the biggest problems facing manufacturers of goods. Every year billions of dollars of potential profits are lost due to this practice. The conventional way of stopping counterfeiting is primarily through law enforcement actions. Those who are caught counterfeiting or promoting counterfeiting are arrested and prosecuted. Due to the lucrative business of counterfeiting, law enforcement actions are ineffective in stopping counterfeiting. Today in spite of all the efforts of the justice system billions of dollars worth of goods are counterfeited. Another method used today by manufactures to deter counterfeiting of their goods is by sewing or adding an authentication tag to their goods. This method is not very effective since the counterfeiter makes a counterfeit tag and adds it to the counterfeit good. Also most tags are added within an object, not outside of such object since the tag interferes with the appearance of such object.

The embodiments described hereinafter were developed in light of these and other disadvantages of existing means of stopping counterfeiting.

### SUMMARY

An anti-counterfeiting method is disclosed utilizing a microchip transmitter, a wireless web enable device which receives a code word from the microchip transmitter, and a Code verification server that makes use of a database in order to authenticate the code word received by the wireless web enable device and relays the results back to such device. The purpose of this invention is not to eliminate counterfeiting. It is the intent of this invention to cut the sale volume of counterfeit goods by discouraging anyone from buying a counterfeit product.

### BRIEF DESCRIPTION OF THE DRAWING

These and other features and advantages will be apparent from the following detailed description and the appended claims, taken in conjunction with the accompanying drawings, in which:

FIG. 1 is a diagram a wireless authentication system, according to an exemplary embodiment, having a microchip, a wireless web enable device, a code verification server, a database and merchant terminals working in conjunction to authenticate a code word transmitted by the microchip.

FIG. 2 is an exemplary view of a code word.

FIG. 3 is an exemplary view of a website accessed by a WAP enable device.

FIG. 4 is an exemplary view of an authentication result.

### DETAILED DESCRIPTION

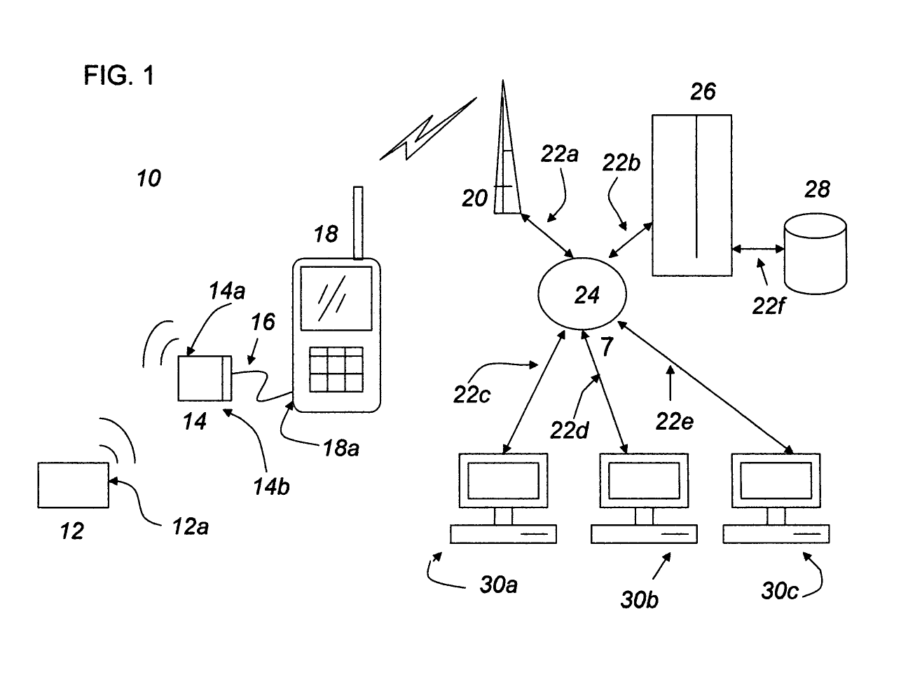

Referring to FIG. 1, a wireless authentication system 10 is illustrated. This system includes a microchip transmitter 12, a wireless web enabled device such as a Personal Digital Assistant (PDA) 18, a wireless receiver 14, a wireless network 20, a code verification server 26, the Internet 24, a database 28 and merchant terminals 30(a), 30(b) and 30(c).

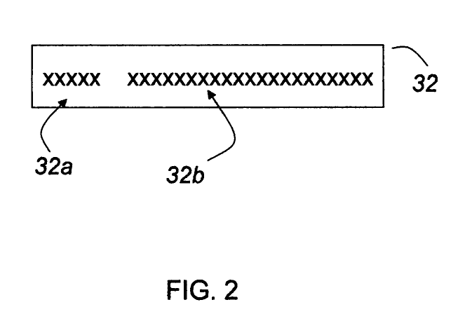

As described in details below, a wireless microchip transmitter 12 is a small chip which uses a low power radio frequency transmission method such as Bluetooth or Wi-Fi. The transmitter continuously transmits a coded word 32, as shown in FIG. 2. The coded word 32 is composed of framing bits 32(a) and data bits 32(b). The framing bits 32(a) are essential to identify the start of the data bits 32(b). The data bits 32(b) are a coded word which identifies the product and many of its qualities. The transmitted coded word 32 is received by a wireless receiver 14.

The wireless receiver 14, is a low power radio frequency receiver using method such as Bluetooth or WiFi technology. The wireless receiver 14 can be either a stand alone device connected by a cable 16 from input/output port 14(b) of the wireless transmitter 14 to input/output port 18(a) of the wireless web enable device 18. Cable 16 may be a serial, USB, or other appropriate connecting cable. The wireless receiver 14 can also be integrated within the wireless web enable device 18. In such case, the wireless receiver 14 and the wireless web enable device 18 is one unit.

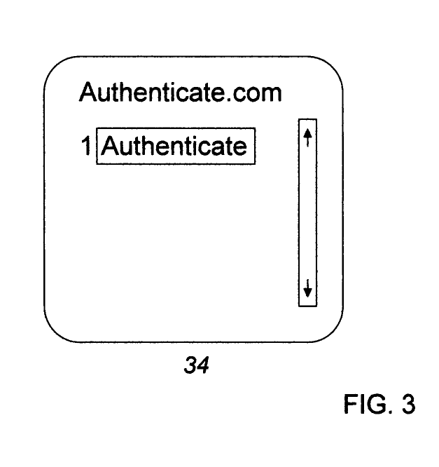

The wireless web enable device 18 receives the code word 32 via the cable 16 which is connected to the wireless receiver 14. The wireless web enable device 18 contains an operating system as found in all wireless telephone or handheld computer. The wireless web enable device 18 contains a web browser 34, as shown in FIG. 3, using wireless web technology such as WAP or any other technology that allows a cell phone or handheld computer to access an Internet site. The wireless web enable device 18 using a wireless web technology such as WAP, transmits the code word via a wide area wireless network 20.

The wireless network 20 is not limited to the cell phone network but includes all types of wide area wireless network such as WiFi. The wireless network is connected to the internet via a base station contained within the wireless network 20. The idea of a base station is well known to those skilled in the art.

The code word 32 is routed through the Internet 24, which is a global networking system comprising of numerous sub-network and connecting computers, to its destination code verification server 26. cables 22(a)-22(e) are high speed internet lines. These lines may be T1, T3 or above which transmit data at speeds of 1.44 Mbs or higher.

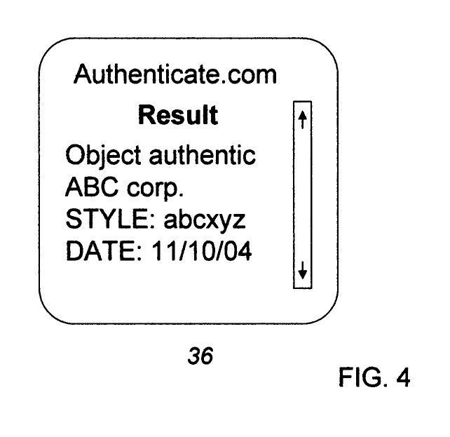

The code verification server 26, is a specialized computer with specialized software which takes input from client computers or other servers, process the input and return a result to the client. The code verification server 26 receives the client request which is the code word 32. The code verification server 26 looks up an entry for the code word 32 in database 28 via high speed data line 22f which may be an Ethernet connection. The code verification server 26 decodes the code word 32 with a deciphering software. The code verification server 26 sends the result 36, as shown in FIG. 4, back to the client, wireless web enable device 18, via the internet 24 and wireless network 20. the wireless enable device 18 displays the complete description of the object and authentication status.

Merchant terminals 30(a)-30(c) are exemplary manufacturer client computers. Each manufacturer is given a guideline on how to encode the microchip 12. When the manufacturer has encoded the microchip 12, the manufacturer has to register the code word 32 with code verification server 26. The manufacturer A via merchant terminal 30(a) sends security data including the code word 32 to code verification server 26 via the internet 24. The code verification server 26 after verifying the security data from the manufacturer, stores the code word in the database 28.

Now, exemplary method of authenticating an object using the authentication system 10 will be discussed. First, the manufacturer of goods, in this case manufacturer A, makes a product. Manufacturer A has a guideline and encodes microchip 12. The manufacturer then embeds microchip 12 in the product. The manufacturer using merchant terminal 30(a) registers the code word 32 by sending the information to code verification server 26 via the internet 24 using high speed data line 22(c). The code verification server 26, after verification of the data sent by the manufacturer, registers the code word 32 in database 28. Registration of the code word is complete.

A consumer buys the good with the wireless microchip transmitter 12 embedded within the product. Anyone with a wireless enable device 18 and wireless receiver 14 is able to verify the authenticity of the product.

In order for a user of a wireless web enable device 18 and wireless receiver 14 to authenticate a product, the user puts the wireless web enabled device 18 in close proximity to the object. The wireless web enabled device 18 is equipped with a wireless receiver 14 that picks up the coded signal 32 from the wireless microchip transmitter 12 which is embedded in the product by the manufacturer. The wireless enable device 18 has the software as mentioned earlier that allows the user to access a website 34 that verifies the authenticity of the code word 32. The wireless enable device 18 accesses the website 34 which resides on code verification server 26 via the wireless network 20 and the Internet 24. The code verification server 26 looks up an entry for the code word 32 in the database 28. If an entry exists, the code verification server 26 deciphers the code word 32 and extracts all the description of the product. The code verification server 26, sends the description of the product to the wireless enable device 18, via the internet 24, the wireless network 20 and the software within the wireless enable device 18. The user of the wireless enable device is able to compare the description received by the code verification server 26 and the product description. If a product does not contain the wireless microchip transmitter 12, the wireless enable device 18 would show a message to that effect. In such case the product is a fake. In case someone is trying to counterfeit the wireless microchip transmitter 12, the encoding would not match and the result would be that the product is not authentic. Again in such case the product is a fake.

Due to the lucrative business of counterfeiting, counterfeiters are able to produce exact duplicate of authentic objects. The counterfeiters know if their counterfeit goods are not exactly like the original, they will not get anyone to buy it. A buyer of a counterfeit good, buy the object because it looks exactly like the original object with no superficial distinction. The buyers try to pass the counterfeit good as an original work, yet they have brought the object at a fraction of the price. The above described invention makes it possible for anyone with a wireless enable device 18 to authenticate any product. Therefore, no matter how closely a counterfeit product resembles the original work, the wireless authentication system 10 can always set them apart. Now that a buyer knows that anyone can easily authenticate their product, he/she will be discouraged to purchase a counterfeit good, since the best thing about buying a counterfeit good is to fool everyone while paying less for the object. One skilled in the art, in light of this disclosure, will recognize other benefits associated with the described embodiments.

Various other modifications to the present invention may occur to those skilled in the art to which the present invention pertains. Accordingly, it is the following claims, including all equivalents, which define the scope of the present invention.

1. A wireless authentication system that wirelessly verifies the authenticity of an object, comprising:
a wireless microchip transmitter configured to transmit an encoded signal using radio frequency transmission technology;
a wireless receiver configured to receive the encoded signal from said wireless microchip transmitter, utilizing radio frequency transmission technology;
a wireless web enable device configured to send and receive data to and from a remote website residing on a remote Internet server, by means of a wireless network;
a wireless communication network;
a global networking system, also known as the Internet;
a code verification server;
a database; and
a set of merchant terminals.

2. A system according to claim 1, wherein said wireless microchip transmitter is a radio frequency transmitter that transmits an encoded radio frequency signal.

3. A system according to claim 1, wherein said wireless receiver is a radio frequency receiver that intercepts the encoded radio frequency signal from said wireless microchip transmitter, and transmits said encoded signal in digital format to said wireless web enable device, via a connection port.

4. A system according to claim 1, wherein said wireless web enable device is a wireless telephone configured to send and receive data to and from a remote website residing on a remote Internet server, and configured to communicate on a wireless network.

5. A system according to claim 1, wherein said wireless web enable device is a computer, such as a held hand computer, with wireless capability configured to send and receive data to and from a remote website residing on a remote Internet server, and configured to communicate on said wireless communication network.

6. A system according to claim 1, wherein said wireless web enable device is a wireless phone with said wireless microchip receiver integrated within the cell phone and configured to send and receive data to and from a remote website residing on a remote Internet server, and configured to communicate on a wireless network.

7. A system according to claim 1, wherein said code verification server is a specialized computer with specialized software configured to take input from said merchant terminals, web clients, client computers, and other servers, process the input and return a result to the client.

8. A system according to claim 1, wherein said merchant terminal is a client computer configured to provide said code verification server, a code word.

9. A system according to claim 1, wherein said database is a software configured to store and retrieve data to and from a storage area within said code verification server

10. A system according to claim 1, wherein said database is a software configured to store and retrieve data to and from a remote storage area via a connection port and return the result of any queries to said code verification server

11. The wireless receiver of claim 3, wherein said connection port is a serial port.

12. A method for authenticating an object using the wireless authentication system, comprising;
a manufacturer encoding a wireless microchip transmitter with a code word for transmission:
said code word is registered with a code verification server using said manufacturer merchant terminal;
said code verification server receives said code word, verifies said manufacturer identity, verifies said code word format, and stores said code word in a database.

13. The method of claim 12, further comprising:
said wireless microchip transmitter, transmitting said code word by means of radio frequency transmission;
said code word is intercepted by a wireless radio frequency receiver;
said receiver sends a digital copy of said code word to a wireless web enable device;
said wireless web enable device accesses a remote website on said remote code verification server and sends said code word to said code verification server via the wireless network and the internet;
said code verification server compares the code word to entries in said database for an exact match;
